(19) United States
(12) Patent Application Publication
(10) Pub. No.: US 2015/0129258 A1
(43) Pub. Date: May 14, 2015

(54) HOE FOR FACILITATING WORKING ON AT LEAST TWO SIDES OF A PLANT SIMULTANEOUSLY

(71) Applicants: George H. Macey, PRESTON, MD (US); VISTA G. CHEESMAN, PRESTON, MD (US)

(72) Inventors: George H. Macey, PRESTON, MD (US); VISTA G. CHEESMAN, PRESTON, MD (US)

(21) Appl. No.: 14/074,894

(22) Filed: Nov. 8, 2013

(51) Int. Cl. A01B 1/12

(52) U.S. Cl. CPC A01B 1/12
USPC 172/378

(57) ABSTRACT

A hoe for facilitating working on at least two sides of a plant simultaneously which comprises a handle, a shank, a ferrule, and a blade. The blade has a first inner angled edge of a first outcrop, and a second inner angled edge of a second outcrop which form between them a substantially V-shaped opening. A flat inner edge cuts off the inner point of the substantially V-shaped opening. The substantially V-shaped opening is for partially encompassing a plant for uprooting, as well as for forming parallel furrows, the sides of which are formed by the inner angled edges as well as by outer angled edges of the blade.

### BACKGROUND OF THE INVENTION

1. Field of the Invention

The present invention relates to a hoe, and more particularly, a HOE FOR FACILITATING WORKING ON AT LEAST TWO SIDES OF A PLANT SIMULTANEOUSLY.

2. Description of the Prior Art

Numerous innovations for hoes have been provided in the prior art that will be described. Even though these innovations may be suitable for the specific individual purposes to which they address, however, they differ from the present invention.

A FIRST EXAMPLE, U.S. Pat. No. 529,562, Published/Issued on Nov. 20, 1894, to Mortenson, C. G. teaches an invention that consists of a peculiarly shaped blade with a hinge joint, latch, and strengthening brace, and an attachment for extracting roots and weeds.

A SECOND EXAMPLE, U.S. Pat. No. 4,093,031, Published/Issued on Jun. 6, 1978, to Portz teaches a pendulum type hoe has a stirrup-shaped blade mounted to the fork of a handle for limited articulation. Inturned flanges of the blade engage hourglass shaped openings in the fork arms, the flanges being retained between reinforcing bars which project through the openings and afford strength, wear resistance, and limited resilience to the blade. The fork is made in two separable parts whereby any component of the hoe may be replaced.

A THIRD EXAMPLE, U.S. Pat. No. 4,377,211, Published/Issued on Mar. 22, 1983, to Voss teaches a garden hoe features a wide cutting edge for normal hoeing, at one end of which is a pair of cutting edges meeting at a right angle for bordering a garden or a walk and at the other end of which is a short cutting edge for chopping or trenching. A hooked cutting edge for pruning is also incorporated in the hoe which may have a long or short handle.

A FOURTH EXAMPLE, U.S. Pat. No. 4,730,679, Published/Issued on Mar. 15, 1988, to Tallerico, Et Al. teaches a garden tool which includes a handle and a connected head part. The head part includes multiple sides each formed into a tool part for performing a specific garden task.

A FIFTH EXAMPLE, U.S. Pat. No. 4,890,679, Published/Issued on Jan. 2, 1990, to Jacobs teaches a one-piece tool for performing controlled and exacting cuts for the removal of weeds 26 not susceptible to the strike of a horizontal hoe blade 24, as well as small limbs from trees and bushes, these by striking downward, the former by an oblique upward strike with the scythe-cutting edges 22.

A SIXTH EXAMPLE, U.S. Pat. No. 5,207,466, Published/Issued on May 4, 1993, to Ohlson teaches a garden tool having an elongate shaft with a handle on one end of the shaft and the opposite end of the shaft having a plurality of circumferentially spaced generally axially extending cultivating and weeding prongs, and the shaft and handle permitting a gardener to use the tool in a generally upright position for soil loosening, cultivating and weeding by rotary and rocking maneuvers of the handle and agitating the prongs, and for optionally spearing trash or aerating sod.

A SEVENTH EXAMPLE, U.S. Pat. No. 5,479,993, Published/Issued on Jan. 2, 1996, to Bojar teaches a disclosure is made of an adjustable pitch garden hoe tool head (16) as an article of manufacture wherein the pitch of the garden hoe tool head (16) head assembly can be adjusted to control the dig or “bite” into the soil and comprises ferrule legs (11, 11′) mounted on an extended handle (1) and adjustable pitch garden hoe tool head (16) mounted on the ferrule legs (11, 11′) and a modified compression V spring (10) having a three sided trapezoidal shape with an apex segment of modified compression V spring (23) which is a straight segment at the apex mounted within the ferrule legs (11, 11′) and arms (9, 9′) of the modified compression V spring (10) extending into pitch set slots (4, 4′) and pitch set stops (3, 3′) in vertical sides (5, 5′) of base blade (6) of the garden hoe tool head (16). Further disclosure is made of a cutting notch (8) on the bottom back of either or both of vertical sides 5, 5′ of base blade and the cutting notch and all edges of vertical sides 5, 5′ of base blade and garden hoe tool base blade (6) are sharpened to a cutting edge.

AN EIGHTH EXAMPLE, U.S. Pat. No. 5,628,370, Published/Issued on May 13, 1997, to Chrysler teaches an invention is a wooden handled, heart shaped, garden tool configured to perform various garden tasks. The tool includes multiple edges and angles configured to perform various garden tasks and a bolt attached thereon at 36.degree. to mate with a handle connector equipped with three different angled mounting bosses. One boss comes straight from the end of the connector, the second boss is ninety degrees from the connector and handle, and the third boss is fifty four degrees from the connector and handle. A coupling has also been designed for the center of the of the handle to allow it to be taken apart for the ease of shipping or storing or to add a longer length handle section.

It is apparent now that numerous innovations for hoes have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a HOE FOR FACILITATING WORKING ON AT LEAST TWO SIDES OF A PLANT SIMULTANEOUSLY that avoids the disadvantages of the prior art.

ANOTHER OBJECT of the present invention is to provide a HOE FOR FACILITATING WORKING ON AT LEAST TWO SIDES OF A PLANT SIMULTANEOUSLY that is simple and inexpensive to manufacture.

STILL ANOTHER OBJECT of the present invention is to provide a HOE FOR FACILITATING WORKING ON AT LEAST TWO SIDES OF A PLANT SIMULTANEOUSLY that is simple to use.

BRIEFLY STATED, STILL YET ANOTHER OBJECT of the present invention is to provide a HOE FOR FACILITATING WORKING ON AT LEAST TWO SIDES OF A PLANT SIMULTANEOUSLY that may facilitate creating a pair of parallel furrows.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

The figures of the drawings are briefly described as follows:

FIG. 1 is a diagrammatic perspective view, illustrating a person agitating the surface of the soil around a base of a plant utilizing the present invention;

FIG. 2 is an enlarged diagrammatic perspective view thereof, of just the hoe per se, as shown in the area enclosed in the dotted circle indicated by arrow 2 in FIG. 1;

FIG. 3 is a distal end elevational view taken in the direction of arrow 3 in FIG. 2;

FIG. 4 is a proximal end elevational view taken in the direction of arrow 4 in FIG. 2;

FIG. 5 is a left side elevational view taken in the direction of arrow 5 in FIG. 2;

FIG. 6 is a view illustrating a user uprooting a plant through the V-shaped opening of the hoe of the present invention; and

FIG. 7 is a view illustrating the creation of parallel furrows by the hoe of the present invention.

### A MARSHALING OF REFERENCE NUMERALS UTILIZED IN THE DRAWINGS

10 hoe

12 plant

14 handle of hoe 10

16 shank of hoe 10

18 blade of hoe 10

19 ferrule of hoe 10

20 user

22 first outcrop of blade 18 of hoe 10

24 second outcrop of blade 18 of hoe 10

26 flat inner edge of blade 18 of hoe 10

28 first inner angled edge of first outcrop 22 of blade 18 of hoe 10

30 first tip of first outcrop 22 of blade 18 of hoe 10

32 second inner angled edge of second outcrop 24 of blade 18 of hoe 10

34 second tip of second outcrop 24 of blade 18 of hoe 10

36 substantially V-shaped opening of blade 18 of hoe 10

37 soil

38 first outer angled edge of first outcrop 22 of blade 18 of hoe 10

40 second outer angled edge of second outcrop 24 of blade 18 of hoe 10

42 parallel furrows

44 first flat side of blade 18 of hoe 10

46 second flat side of blade 18 of hoe 10

48 top edge of blade 18 of hoe 10

50 first curved corner of blade 18 of hoe 10

52 second curved corner of blade 18 of hoe 10

### DETAILED DESCRIPTION OF THE PREFERRED EMBODIMENT

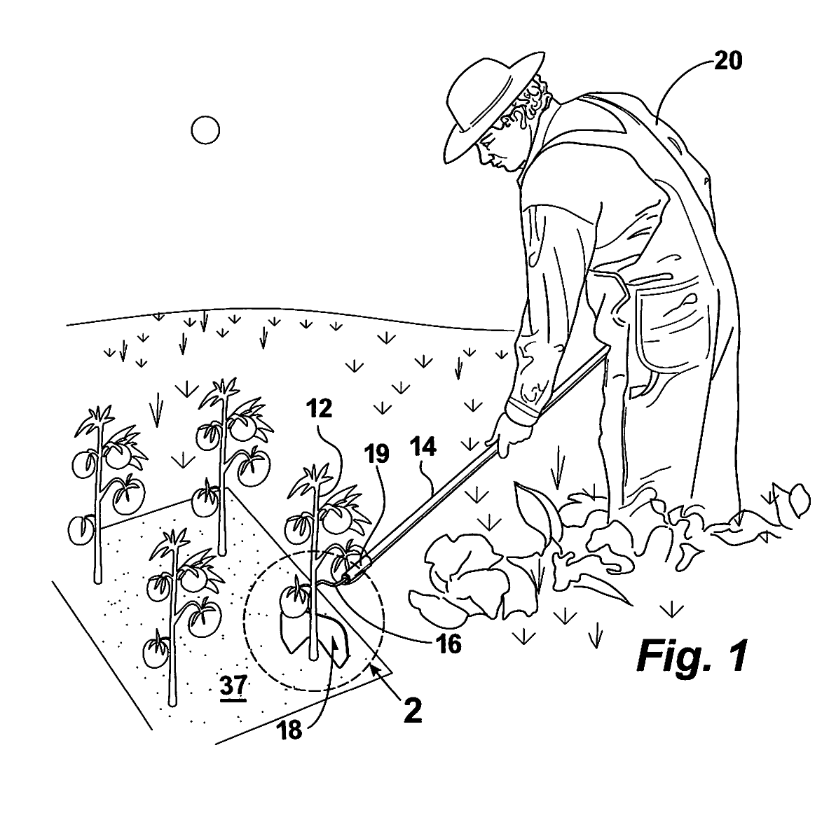

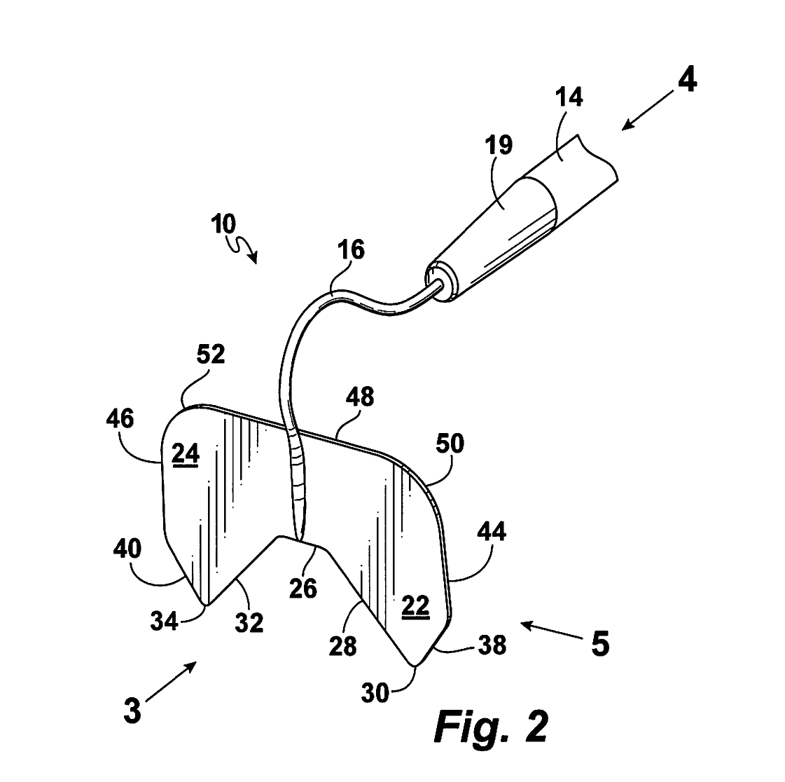

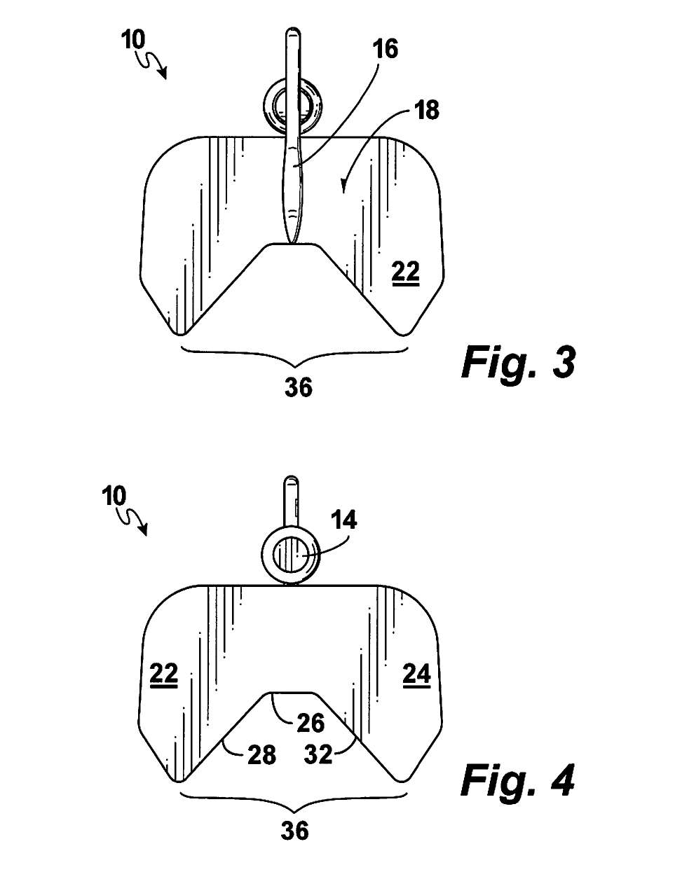

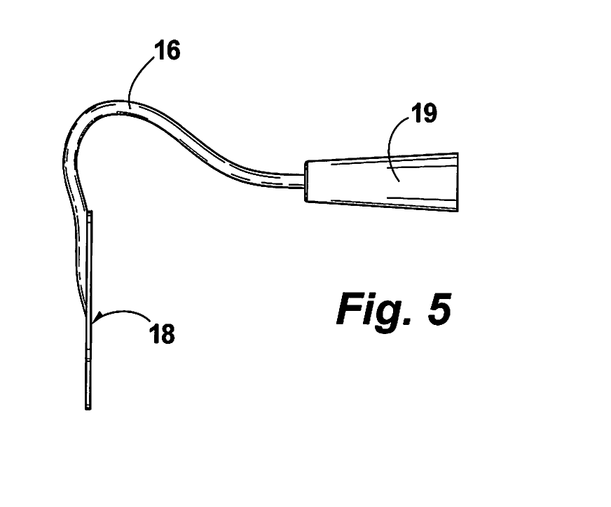

Referring now to the figures, in which like numerals indicate like parts, and particularly to FIGS. 1-5, disclosed is a hoe 10 for facilitating working on at least two sides of a plant 12 simultaneously which comprises a handle 14, a shank 16, a ferrule 19 and a blade 18. Said handle 14 is for holding of said hoe 10 by a user 20. Said shank 16 is for attaching said blade 18 to said handle 14. Said shank 16 is permanently affixed to said blade 18.

### Detailed Description of the Blade 18

Said blade 18 comprises a first outcrop 22, a second outcrop 24, and a flat inner edge 26. Said first outcrop 22 comprises a first inner angled edge 28 and a first tip 30. Said second outcrop 24 comprises a second inner angled edge 32 and a second tip 34.

Said first inner angled edge 28 of said first outcrop 22 and said second inner angled edge 32 of said second outcrop 24 form between them a substantially V-shaped opening 36. Said flat inner edge 26 cuts off the inner point of said substantially V-shaped opening 36 formed between said first outcrop 22 and said second outcrop 24. Said substantially V-shaped opening 36 is for partially encompassing a plant 12 by encompassing two sides of said plant 12 simultaneously for facilitating uprooting thereof by permitting a user 20 to press down upon soil 37 therearound.

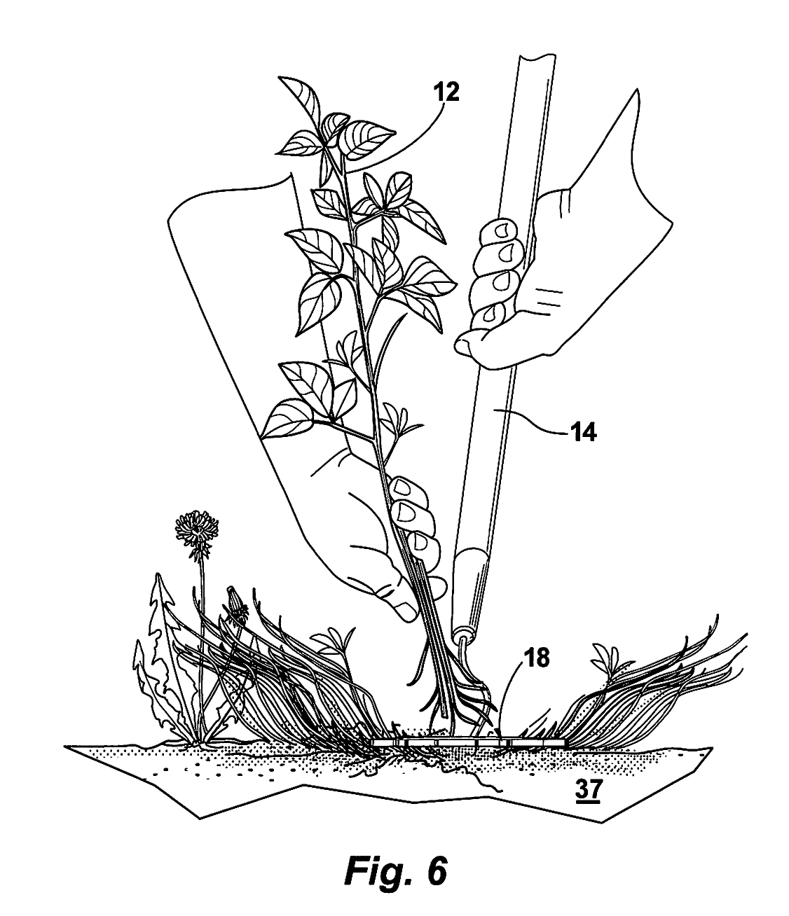

As most clearly shown in FIG. 6, this facilitates uprooting by preventing a plant 12 being uprooted from taking excessive soil 37 up with it by confining the egress of soil to the area within the substantially V-shaped opening 36. The cutting off of the tip of said substantially V shaped opening 36 by said flat inner edge 26 further facilitates the uprooting of plants 12 by making the blade 18 of the hoe 10 more proximal to the plant 12 than would be the case with the tip not cut off when used for vertical uprooting. It is understood that the preferred use for such uprooting is for weeding of a garden or the like, but that other plants 12 than weeds may be uprooted by the same use.

To further facilitate uprooting and plant removal, said first inner angled edge 28, said second inner angled edge 32 and said flat inner edge 26 are sharp. This permits the hoe 10 to also act as a cutting implement when removing or uprooting weeds, by, for example, being used in a hacking motion, wherein said first inner angled edge 28 and said second inner angled edge 32 both act to cut themselves, and guide the item being cut towards said flat inner edge 26. By the first inner angled edge 28 and second inner angled edge 32 being angled, they may guide and substantially trap an item being hacked therein, while still having the item being hacked impact said flat inner edge 26 in parallel to the direction of force applied.

### Detailed Description of the First 22 and Second 24 Outcrops

Said first outcrop 22 further comprises a first outer angled edge 38 and said second outcrop 24 further comprises a second outer angled edge 40. Said first outer angled edge 38 and said first inner angled edge 28 meet each other, and said first tip 30 is formed at the point where said first outer angled edge 38 and said first inner angled edge 28 meet. Likewise, said second outer angled edge and said second inner angled edge meet each other, and said second tip 34 is formed at the point where said second outer angled edge 40 and said second inner angled edge 32 meet.

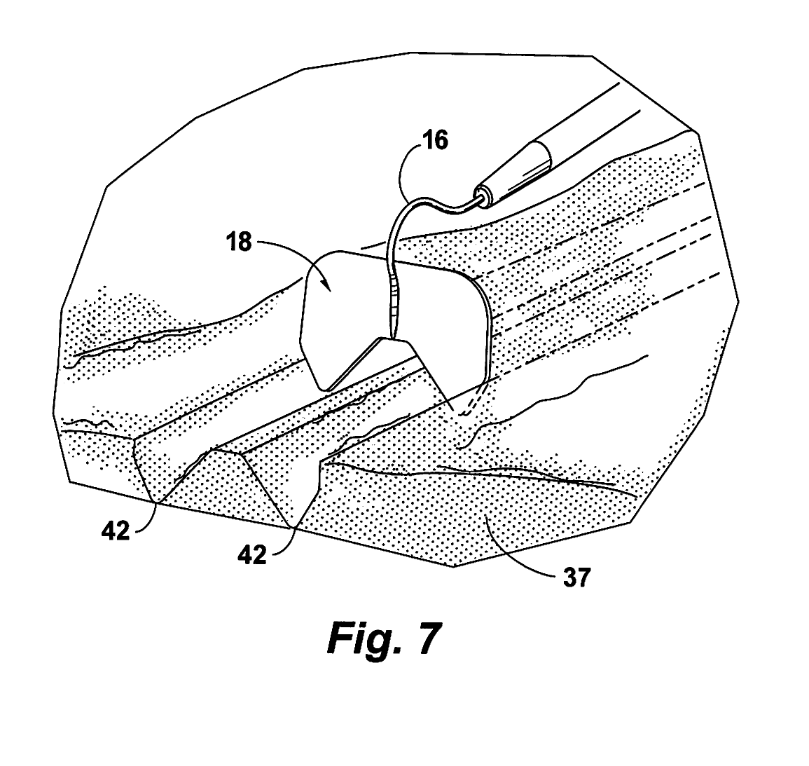

As illustrated in FIG. 7, this structure means that said first outcrop 22 and said second outcrop 24 are useful for facilitating the simultaneous creating of two parallel furrows 42, wherein said outer angled edges 38, 40 and said inner angled edges 28, 32 are for facilitating forming the sides of the furrows 42. The flat inner edge 26 further provides for permitting even spacing of the furrows 42.

### Detailed Description of the Sides and Top of the Blade 18

Said blade 18 further comprises a first flat side 44 and a second flat side 46. Said first flat side 44 and said second flat side 46 are for smoothing soil, and a user 20 may turn said hoe on its side to utilize said first flat side 44 or said second flat side 46 for smoothing soil. Further, said first flat side 44 abuts said first outer angled edge 38, and said second flat side 46 abuts said second outer angled edge 40. Said blade 18 still further comprises a top edge 48.

Said blade still further comprises a first curved corner 52 and a second curved corner 54. Said first curved corner 52 is between said first flat side 44 and said top edge 48, and said second curved corner 54 is between said second flat side 46 and said top edge 48. This configuration facilitates smoothing by said flat sides 44, 46 being abutted on both sides by gradual slopes as opposed to stiff rectangular cutoffs, allowing a user 20 more ability to adjust the hoe 10 at an angle without creating deep ruts from a sharp corner.

Said shank 16 is affixed to said blade 18 so that it extends outward over said top edge 48, and said shank bends so that it attaches said blade 18 to said handle 14 such that said handle 14 is perpendicular to said blade 18. This attachment is accomplished by said ferrule 19 which is for attaching said shank 16 to said handle 14. In a preferred construction, said blade 18 is formed from a single piece of stamped metal for simplicity and lower cost.

It will be understood that each of the elements described above, or two or more together, may also find a useful application in other types of constructions differing from the types described above.

While the invention has been illustrated and described as embodiments of a HOE FOR FACILITATING WORKING ON AT LEAST TWO SIDES OF A PLANT SIMULTANEOUSLY, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. A multi-function hoe for facilitating working on at least two sides of a plant simultaneously which comprises:
a) a handle;
b) a shank; and
c) a blade;
wherein said handle is for holding of said hoe by a user;
wherein said shank attaches said blade to said handle;
wherein said shank is permanently affixed to said blade;
wherein said blade further comprises:
a) a first outcrop;
b) a second outcrop; and
c) a flat inner edge;
wherein said first outcrop of said blade comprises:
a) a first inner angled edge; and
b) a first tip;
wherein said second outcrop of said blade comprises:
a) a second inner angled edge; and
b) a second tip;
wherein said first inner angled edge of said first outcrop of said blade and said second inner angled edge of said second outcrop of said blade form between them a substantially V-shaped opening;
wherein said flat inner edge of said blade is for cutting off the inner point of said substantially V-shaped opening of said blade formed between said first outcrop of said blade and said second outcrop of said blade;
wherein said substantially V-shaped opening of said blade is for partially encompassing a plant for facilitating uprooting thereof by permitting a user to press down upon soil therearound;
wherein said first outcrop of said blade further comprises a first outer angled edge;
wherein said second outcrop of said blade further comprises a second outer angled edge;
wherein said blade further comprises a:
a) first flat side; and
b) a second flat side;
wherein said shank extends to said flat inner edge of said blade; and
wherein said flat inner edge of said blade is at an elevation that is higher than that of where said first outer angled edge of said first outcrop of said blade meets said first flat side of said blade and where said second outer angled edge of said second outcrop of said blade meets said second flat side of said blade.

2. The hoe of claim 1 wherein said first inner angled edge, said second inner angled edge and said flat inner edge are sharp.

3. The hoe of claim 2
wherein said first outer angled edge and said first inner angled edge meet; and
wherein said second outer angled edge and said second inner angled edge meet.

4. The hoe of claim 3 wherein said first tip is formed at the point where said first outer angled edge and said first inner angled edge meet;
wherein said second tip is formed at the point where said second outer angled edge and said second inner angled edge meet; and
wherein said first outcrop and said second outcrop are for facilitating the simultaneous creating of two parallel furrows, wherein said outer angled edges and said inner angled edges are for facilitating forming the sides of the furrows.

5. The hoe of claim 4
wherein said first flat side and said second flat side are for smoothing soil; and
wherein a user may turn said hoe on its side to utilize said first flat side or said second flat side for smoothing soil.

6. The hoe of claim 5 wherein said first flat side abuts said first outer angled edge; and
wherein said second flat side abuts said second outer angled edge.

7. The hoe of claim 6 wherein said blade further comprises a top edge;
wherein said shank is affixed to said blade so that it extends outward over said top edge; and
wherein said shank bends so that it attaches said blade to said handle such that said handle is perpendicular to said blade.

8. The hoe of claim 7 wherein said hoe further comprises a ferrule, wherein said ferrule is for attaching said shank to said handle.

9. The hoe of claim 7 wherein said blade further comprises a first curved corner and a second curved corner;
wherein said first curved corner is between said first flat side and said top edge; and
wherein said second curved corner is between said second flat side and said top edge.

10. The hoe of claim 9 wherein said blade is formed from a single piece of stamped metal.
